(19) United States
(12) Patent Application Publication
(10) Pub. No.: US 2023/0394238 A1
(43) Pub. Date: Dec. 7, 2023

(54) AUTOMATED SELECTION OF ARTIFICIAL INTELLIGENCE MODELS FOR PERFORMING ENTITY EXTRACTION ON DOCUMENTS MAINTAINED BY A COLLABORATION PLATFORM

(71) Applicant: Microsoft Technology Licensing, LLC, Redmond, WA (US)

(72) Inventors: Sean James SQUIRES, Edmonds, WA (US); Anupam FRANCIS, Hyderabad (IN); Liming CHEN, Redmond, WA (US); Ramesh Kumar Sathyanarayana KASTURI, Hyderabad (IN); Krishna Kant GUPTA, Redmond, WA (US); Ishaan THAKKER, Redmond, WA (US); Anamika BEDI, Redmond, WA (US); Nicholas Anthony BUELICH, II, Bellevue, WA (US); Miaoting FENG, Redmond, WA (US)

(21) Appl. No.: 17/831,373

(22) Filed: Jun. 2, 2022

(51) Int. Cl. G06F 40/295

(52) U.S. Cl. CPC G06F 40/295; G06F 3/04847

(57) ABSTRACT

A collaboration platform provides a collaboration user interface (“UI”) through which a user can request a recommendation of an artificial intelligence (“AI”) model for performing entity extraction on documents in a document library maintained by the collaboration platform. In response to receiving such a request, the collaboration platform can select candidate documents from the documents in the library and process the candidate documents using AI models configured to extract entities from the one or more documents. The collaboration platform can then select one of the AI models based on the processing. The collaboration platform can also provide functionality for performing automated document tagging using term sets on documents maintained by the collaboration platform.

### BACKGROUND

Some computing platforms provide collaborative environments that facilitate communication and interaction between two or more participants. For example, organizations may utilize a computer-implemented collaboration platform that provides functionality for enabling users to create, share, and collaborate on documents.

Users of collaboration platforms such as those described briefly above may generate and utilize large numbers of documents. As a result, locating documents containing information about a desired topic can be time consuming and difficult, if not impossible. Manual tagging of documents with metadata to facilitate subsequent searching can be performed, but can also be time consuming and inconsistent.

In order to address the technical problem described above, artificial intelligence (“AI”) models (which might also be referred to herein as machine learning (“ML”) models) have been developed that can perform entity extraction on documents maintained by a collaboration platform. Entity extraction, sometimes referred to as “named entity extraction,” is a text analysis technique that uses Natural Language Processing (“NLP”) to automatically pull out, or “extract,” specific data from documents, and classify the data according to predefined categories. The extracted text can then be utilized as metadata to facilitate searching for the documents, by automated processes, and in other ways.

Because training AI models can be complex and time consuming, some collaboration platforms provide previously-trained AI models capable of extracting various types of entities from documents. However, it may be difficult for many users to select the best previously-trained AI model for extracting entities from a particular type of document. As a result, users may engage in a trial-and-error process through which they test available AI models using a set of test documents.

Using a trial-and-error process to select an appropriate AI model can, however, be time consuming and utilize significant computing resources, such as processor cycles, memory, storage, and power. This process may need to be repeated for each document type, thereby compounding the inefficient use of time and computing resources. Moreover, at the end of such a trial-and-error process, the user might still not select the best AI model for a particular document type.

One alternative to the process of trial-and-error described above is to allow users to train their own AI models to perform entity extraction, which might be referred to herein as “custom AI models.” Custom training of AI models, however, can be difficult for users that do not have appropriate technical expertise and, as with the trial-and-error process described above, can utilize significant computing resources such as processor cycles, memory, storage, and power.

It is with respect to these and other technical challenges that the disclosure made herein is presented.

### SUMMARY

Technologies are disclosed herein for automated selection of AI models capable of performing entity extraction on documents maintained by a collaboration platform. Through implementations of the disclosed technologies, AI models for performing entity extraction can be identified and suggested to users of a collaboration platform in an automated fashion, thereby freeing users from having to perform trial-and-error processes to select appropriate AI models. Implementations of the disclosed technologies can also reduce or eliminate the need for users to create custom AI models by selecting previously-trained AI models that are appropriate for extracting entities from documents in a document library maintained by a collaboration platform.

Automated selection of AI models for performing entity extraction and reducing or eliminating the need to train custom AI models can reduce the utilization of computing resources, such as memory and processor cycles, by computing devices implementing the disclosed technologies. Other technical benefits not specifically mentioned herein can also be realized through implementations of the disclosed subject matter.

According to various embodiments, a computer-implemented collaboration platform is disclosed that provides functionality for enabling users to create, share, and collaborate on documents. Documents maintained by the collaboration platform may be stored in document libraries. Additionally, the collaboration platform may provide a user interface (“UI”), which may be referred to herein as the “collaboration UI,” through which users of the collaboration platform can perform various types of operations on documents stored in document libraries.

In one embodiment, the collaboration UI provides functionality through which a user can request a recommendation of an AI model for performing entity extraction on documents in a document library maintained by the collaboration platform. In response to receiving such a request, the collaboration platform can select several candidate documents from the documents in the document library and process the selected candidate documents using AI models configured for entity extraction. The AI models might be previously-trained AI models or custom AI models. The collaboration platform can then select one of the AI models based on the results of the processing. For example, the AI model that is capable of extracting the greatest number of entities from the candidate documents may be selected.

In one embodiment, the collaboration UI identifies the selected AI model to the user. The collaboration UI can also identify the entities that the selected AI model can extract from the candidate documents and receive a selection from a user of the entities that are to be extracted from documents in the document library. The user can then request that the selected AI model extract the selected entities from selected documents in the document library. In some embodiments, the collaboration platform causes the selected AI model to extract entities from new documents added to the document library in response to the new documents being added to the document library.

In one embodiment, the collaboration UI includes a UI control which, when selected, will cause the collaboration platform to create a new content type for documents in a document library. The new content type defines a document type for the documents in the document library. The new content type also defines a schema identifying the selected entities that the selected AI model can extract from the documents in the document library.

In some embodiments, the collaboration platform also provides functionality for performing automated document tagging using term sets on documents maintained by the collaboration platform. In these embodiments, user input can be received by way of the collaboration UI associating a term set with a document library. The term set defines terms that are to be utilized to replace entities extracted from documents in a document library.

Once a term set has been associated with a document library, entities extracted from the documents in the document library can be compared to terms in the term set. Entities extracted from the documents in the document library can then be modified based on the comparison. For example, and without limitation, an entity extracted from a document in the document library might be replaced with a synonym or a preferred term for the extracted entity defined by the term set. The modified entities extracted from the documents can then be stored in association with the document library and displayed in the collaboration user interface. Modification of entities extracted from documents in a document library using a term set might also be performed in response to new documents being added to a document library in some embodiments.

As discussed briefly above, implementations of the technologies disclosed herein provide various technical benefits such as, but not limited to, reducing the number of operations that need to be performed by a user in order to select and utilize an appropriate AI model capable of extracting entities from documents in a document library maintained by a collaboration platform. This automated capability can provide greater efficiencies in productivity, as well as ensure consistent tagging of documents, which can support data discovery, process automation, compliance with security and retention policies, and other operations. As discussed above, the disclosed technologies can also reduce the utilization of computing resources, such as memory and processor cycles, by computing devices implementing aspects of the disclosed subject matter. Other technical benefits not specifically identified herein can also be realized through implementations of the disclosed technologies.

It should be appreciated that the above-described subject matter can be implemented as a computer-controlled apparatus, a computer-implemented method, a computing device, or as an article of manufacture such as a computer readable medium. These and various other features will be apparent from a reading of the following Detailed Description and a review of the associated drawings.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A is a network and computing system architecture diagram showing aspects of a mechanism disclosed herein for automated selection of AI models for performing entity extraction on documents maintained by a collaboration platform, according to one embodiment disclosed herein;

FIG. 1B is a network and computing system architecture diagram showing aspects of a mechanism disclosed herein for automated tagging of documents maintained by a collaboration platform utilizing term sets, according to one embodiment disclosed herein;

FIG. 2A is a UI diagram illustrating aspects of a collaboration user interface provided by the collaboration platform shown in FIGS. 1A and 1B, according to one embodiment disclosed herein;

FIG. 2B is a UI diagram illustrating additional aspects of the collaboration user interface provided by the collaboration platform shown in FIGS. 1A and 1B, according to one embodiment disclosed herein;

FIG. 2C is a UI diagram illustrating additional aspects of the collaboration user interface provided by the collaboration platform shown in FIGS. 1A and 1B, according to one embodiment disclosed herein;

FIG. 2D is a UI diagram illustrating additional aspects of the collaboration user interface provided by the collaboration platform shown in FIGS. 1A and 1B, according to one embodiment disclosed herein;

FIG. 3 is a UI diagram illustrating additional aspects of the collaboration user interface provided by the collaboration platform shown in FIGS. 1A and 1B, according to one embodiment disclosed herein;

FIG. 4 is a flow diagram showing aspects of an illustrative routine for performing entity extraction on documents maintained by the collaboration platform shown in FIGS. 1A and 1B, according to one embodiment disclosed herein;

FIG. 5A is a UI diagram illustrating additional aspects of the collaboration user interface provided by the collaboration platform shown in FIGS. 1A and 1B, according to one embodiment disclosed herein;

FIG. 5B is a UI diagram illustrating additional aspects of the collaboration user interface provided by the collaboration platform shown in FIGS. 1A and 1B, according to one embodiment disclosed herein;

FIG. 5C is a UI diagram illustrating additional aspects of the collaboration user interface provided by the collaboration platform shown in FIGS. 1A and 1B, according to one embodiment disclosed herein;

FIG. 5D is a UI diagram illustrating additional aspects of the collaboration user interface provided by the collaboration platform shown in FIGS. 1A and 1B, according to one embodiment disclosed herein;

FIG. 6 is a flow diagram showing aspects of an illustrative routine for performing automated document tagging using term sets on documents maintained by the collaboration platform shown in FIGS. 1A and 1B, according to one embodiment disclosed herein;

FIG. 7 is a computer architecture diagram showing an illustrative computer hardware and software architecture for a computing device that can implement aspects of the technologies presented herein; and

FIG. 8 is a network diagram illustrating a distributed computing environment in which aspects of the disclosed technologies can be implemented.

### DETAILED DESCRIPTION

The following detailed description is directed to technologies for automated selection of AI models for performing entity extraction on documents maintained by a collaboration platform. As discussed briefly above, various technical benefits can be realized through implementations of the disclosed technologies such as, but not limited to, reducing the number of operations that need to be performed by a user in order to select and utilize AI models capable of extracting entities from documents in a document library maintained by a collaboration platform.

The disclosed technologies can provide greater efficiencies in productivity, as well as ensure consistent tagging of documents, which can support data discovery, process automation, compliance with security and retention policies, and other operations. This, in turn, can reduce the utilization of computing resources, such as memory and processor cycles, by computing devices implementing aspects of the disclosed subject matter. Other technical benefits not specifically mentioned herein can also be realized through implementations of the disclosed subject matter.

While the subject matter described herein is presented in the general context of computing devices implementing a collaboration platform, those skilled in the art will recognize that other implementations can be performed in combination with other types of computing devices, systems, and modules. Those skilled in the art will also appreciate that the subject matter described herein can be practiced with other computer system configurations, including hand-held devices, multiprocessor systems, microprocessor-based or programmable consumer electronics, computing or processing systems embedded in devices (such as wearable computing devices, automobiles, home automation, etc.), minicomputers, mainframe computers, and the like.

In the following detailed description, references are made to the accompanying drawings that form a part hereof, and which are shown by way of illustration specific configurations or examples. Referring now to the drawings, in which like numerals represent like elements throughout the several FIGS., aspects of various technologies for automated selection of AI models for performing entity extraction on documents maintained by a collaboration platform will be described.

FIG. TA is a network and computing system architecture diagram showing aspects of a mechanism disclosed herein for automated selection of AI models for performing entity extraction on documents maintained by a collaboration platform 100, according to one embodiment disclosed herein. As discussed briefly above, the collaboration platform 100 provides functionality for enabling users to create, share, and collaborate on documents 112.

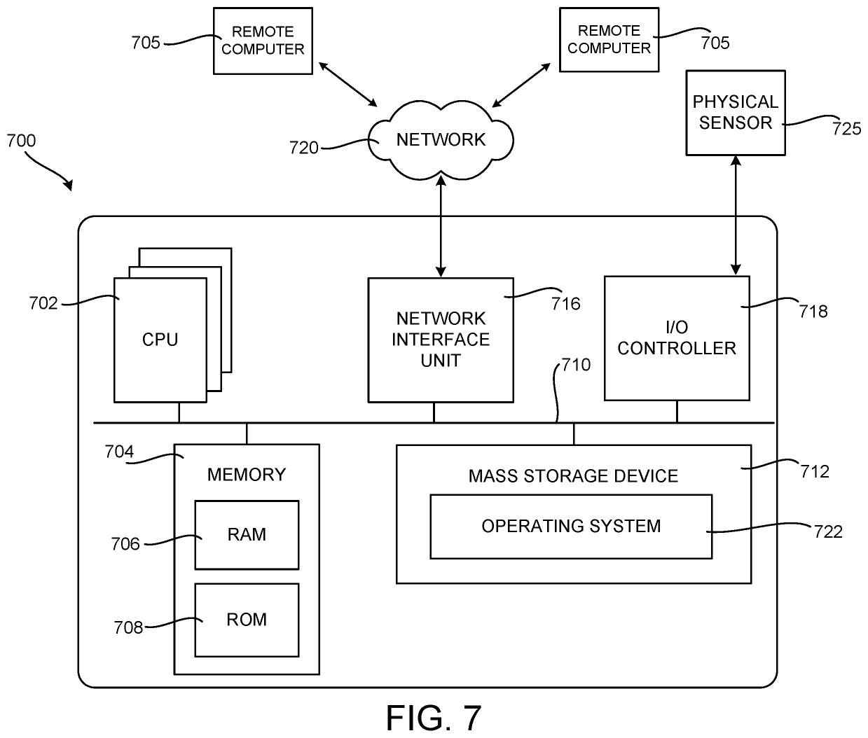

Users can access the functionality provided by the collaboration platform 100 by way of a computing device 104 connected to the collaboration platform 100 by way of a suitable communications network 106. An illustrative architecture for the computing device 104 and for computing devices in the collaboration platform 100 that implement aspects of the functionality disclosed herein is described below with regard to FIG. 7.

Documents 112 maintained by the collaboration platform 100 may be stored in an appropriate data store 110. Users of the collaboration platform 100 can organize the documents 112 into collections of documents 112 called document libraries 108A-108B (which might be referred to collectively as “the document libraries 108”). The document libraries 108 can include documents 112 of the same type or documents 112 of different types. For instance, a document library 108A might contain only resumes or only contracts. Another document library 108B might contain resumes, cover letters, college transcripts, and other documents 122 relating to employment matters.

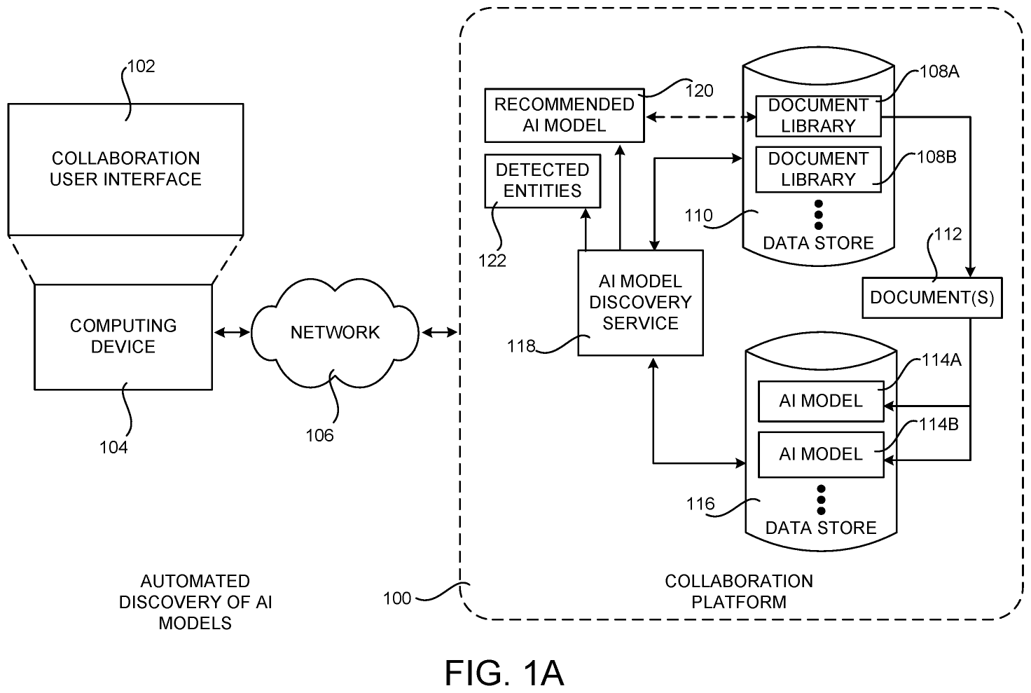

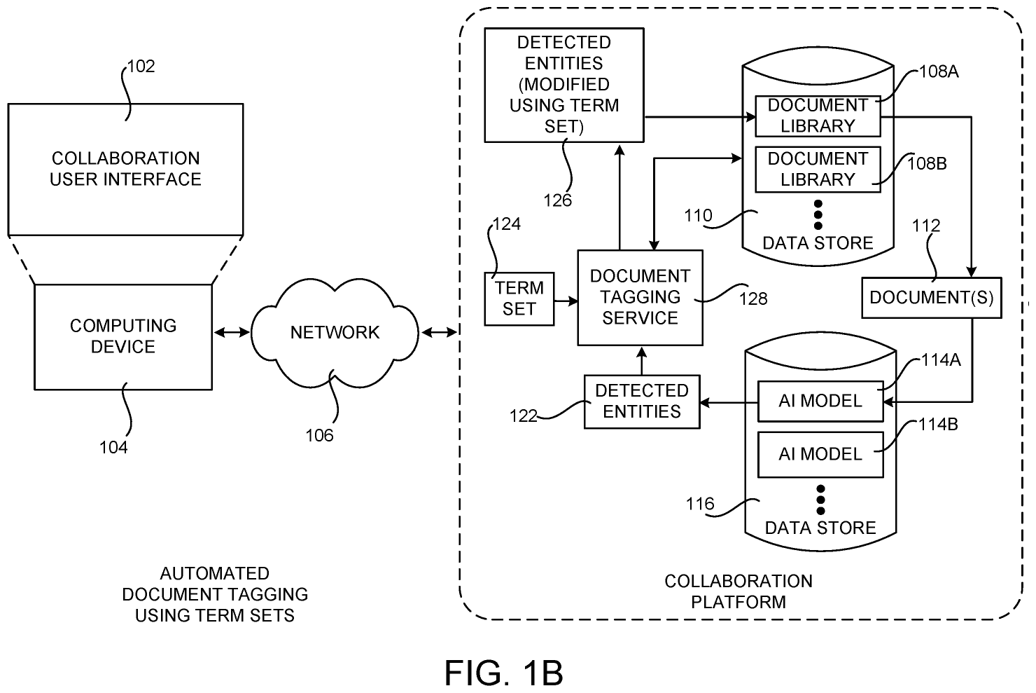

The collaboration platform may also provide a UI 102, which may be referred to herein as the “collaboration UI 102,” through which users of the collaboration platform 100 can access the functionality provided by the collaboration platform 100. For example, the collaboration IU 102 may be utilized to perform various types of operations on documents 112 stored in document libraries 108 maintained by the collaboration platform 100. An application executing on the computing device 102, such as a web browser application (not shown in FIG. 1), generates the collaboration UI 102 based on instructions received from the collaboration platform 100 over the network 106. Other types of applications can generate the collaboration UI 102 in other embodiments.

As described briefly above and in greater detail below, the collaboration UI 102 can also be utilized to access various aspects of the functionality disclosed herein for automated selection of AI models for performing entity extraction on documents 112 maintained by the collaboration platform 100. In order to provide this functionality, the collaboration platform 100 may maintain AI models 114A-114B (which might be referred to collectively as “the AI models 114”) in an appropriate data store 116. The AI models 114 are models that have been trained to perform entity extraction on documents 112 maintained by the collaboration platform 100.

As discussed briefly above, entity extraction, sometimes referred to as “named entity extraction,” is a text analysis technique that uses NLP to automatically pull out, or “extract,” specific data from documents 112, and classify the data according to predefined categories. The collaboration platform 100 can then utilize the extracted text (i.e., the extracted entities) as metadata to facilitate searching for the documents 112, by automated processes, and in other ways.

In some embodiments, the AI models 114 available through the collaboration platform 100 include previously-trained AI models 114. Previously-trained AI models 114 are AI models that have been previously trained to perform entity extraction for a document type, or types, by the operator of the collaboration platform 100. The AI models 114 might also include custom AI models 114. Custom AI models 114 are AI models that have been trained by a user of the collaboration platform 100 to perform entity extraction on a particular document type, or types.

Training of the AI models 114 can include the performance of various types of machine learning including, but not limited to, supervised or unsupervised machine learning, reinforcement learning, self-learning, feature learning, sparse dictionary learning, anomaly detection, or association rules. Accordingly, the AI models 114 can be implemented as one or more of artificial neural networks, decision trees, support vector machines, regression analysis, Bayesian networks, or genetic algorithms. Other machine learning techniques known to those skilled in the art can also be utilized in other embodiments.

In one embodiment, the collaboration UI 102 provides functionality through which a user of the computing device 104 can request a recommendation of an AI model 114 for performing entity extraction on documents 112 in a document library 108 maintained by the collaboration platform 100. In one embodiment, such a request is processed by a network service 118 (which may be referred to herein as the “AI model discovery service 118”) operating within the collaboration platform 100. Other components operating within or external to the collaboration platform 100 might provide this functionality, or aspects of this functionality, in other embodiments.

In response to receiving a request for a recommendation of an AI model 114, the AI model discovery service 118 operating in the collaboration platform 100 can select several candidate documents 112 from the documents 112 in the document library 108 and process the selected candidate documents 112 using AI models 114 configured for entity extraction.

In the example illustrated in FIG. 1A, for instance, candidate documents 112 from the document library 108A have been provided to the AI models 114A and 114B. In turn, the AI models 114A and 114B perform entity extraction on the candidate documents 112. As discussed above, the AI models 114A and 114B might be previously-trained AI models 114 and/or custom AI models 114.

Once the AI models 114 have performed their processing and extracted entities from the candidate documents 112 (which might be referred to herein as the “detected entities 122”), the AI model discovery service 118 operating in the collaboration platform 100 can then select one of the AI models 114A or 114B based on the results of the entity extraction. For example, and without limitation, the AI model discovery service 118 might select the AI model 114A or 114B that extracted the greatest number of detected entities 122 from the candidate documents 112. Other mechanisms for scoring the performance of the AI models 114A and 114B with respect to the candidate documents 112 might be utilized in other embodiments.

Once the AI model discovery service 118 has selected an AI model 114, the selected AI model (which might be referred to as the “selected AI model 120” or the “recommended AI model 120) might be identified to a user of the computing device 104. For example, in one embodiment, the collaboration UI 102 identifies the recommended AI model 120 to the user.

The collaboration UI 102 can also identify the detected entities 122 (i.e., the entities that the recommended AI model 120 can extract from the candidate documents 112) and receive a selection from a user of the detected entities 122 that are to be extracted from documents 112 in the document library 108. The user can then request that the recommended AI model 120 extract the selected entities from selected documents 112 in the document library 108. In some embodiments, the collaboration platform 100 causes the recommended AI model 120 to extract entities from new documents 112 added to the document library 108 in response to the new documents 112 being added to the document library 108.

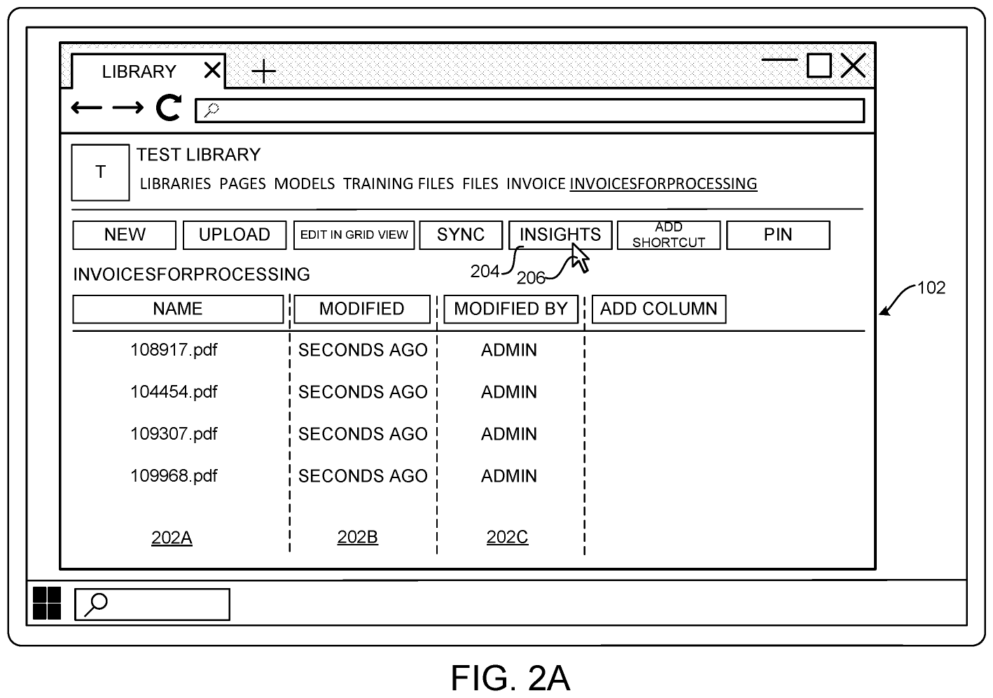

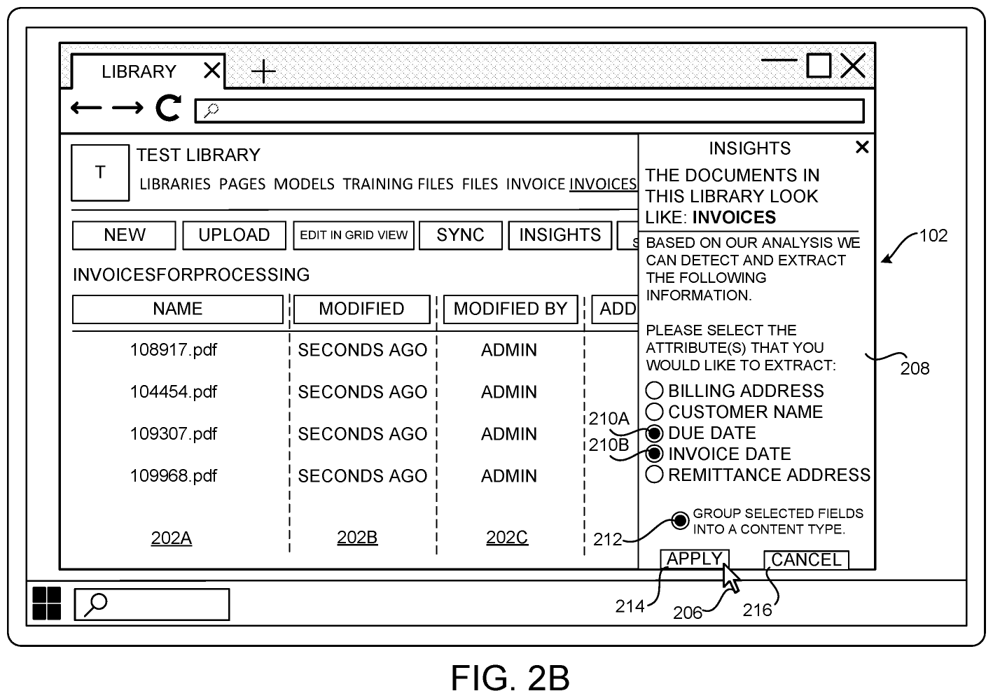

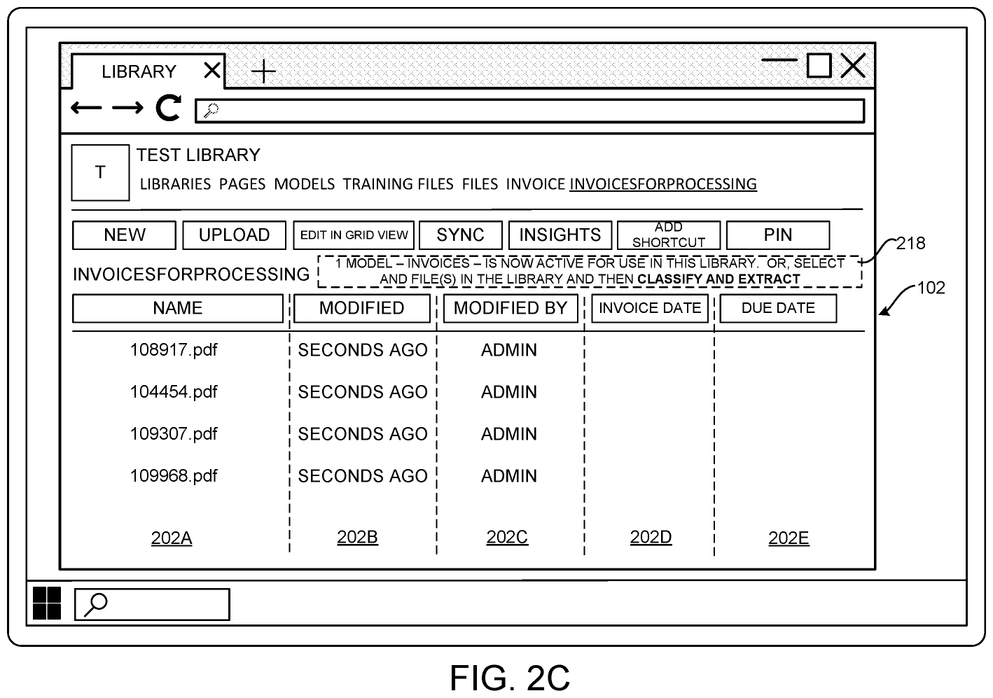

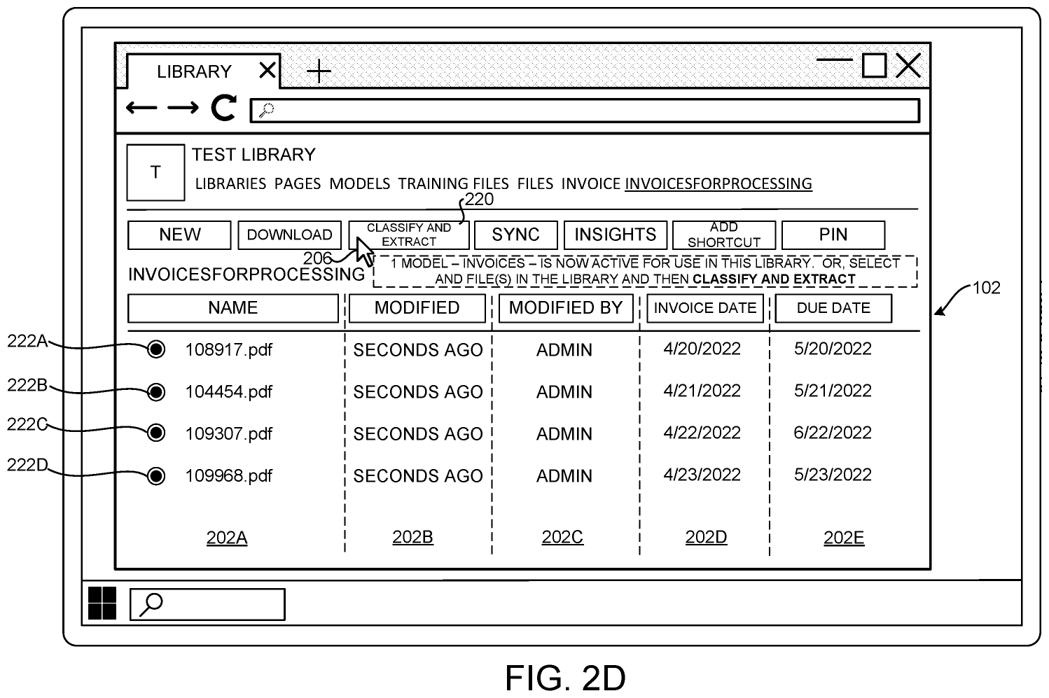

In one embodiment, the collaboration UI 102 includes a UI control which, when selected, will cause the collaboration platform 100 to create anew content type for documents 112 in a document library 108 following the selection of a recommended AI model 120. The new content type defines a document type for the documents 112 in the document library 108. The new content type also defines a schema identifying the selected entities that the recommended AI model 120 can extract from the documents 112 in the document library 108. Additional details regarding the process described above for automated selection of AI models 114 for performing entity extraction on documents 112 maintained by the collaboration platform 100 and the collaboration UI 102 will be provided below with regard to FIGS. 2A-4.

FIG. 1B is a network and computing system architecture diagram showing aspects of a mechanism disclosed herein for automated tagging of documents 112 maintained by the collaboration platform 100 utilizing a term set 124, according to one embodiment disclosed herein. As discussed briefly above, in some embodiments user input can be received by way of the collaboration UI 102 associating a term set 124 with a document library 108. In the illustrated example, for instance, a user has associated a term set with the document library 108A. The term set 124 defines terms that are to be utilized to replace detected entities 122 that are extracted from documents 112 in the document library 108A. For example, and without limitation, the term set 124 might include preferred terms or synonyms for detected entities 122.

Once a term set 124 has been associated with a document library 108, a network service 128 executing in the collaboration platform 116 (which might be referred to herein as the “document tagging service 128”) compares the detected entities 122 extracted from the documents 112 in the document library 108 to terms in the term set 124. Detected entities 122 extracted from the documents 122 in the document library 108 that match terms in the term set 124 can then be modified based on the comparison.

For example, and without limitation, an entity extracted from a document 112 in the document library 108A might be replaced with a synonym or a preferred term for the extracted entity defined by the term set 124. The modified entities 126 extracted from the documents can then be stored in association with the document library 108 and displayed in the collaboration UI 102.

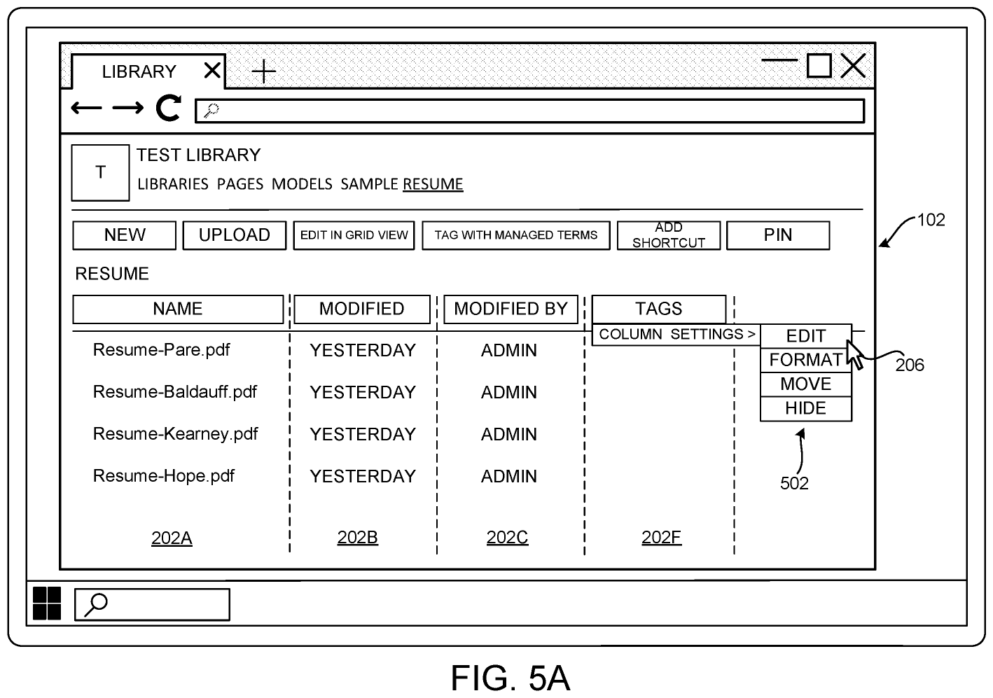

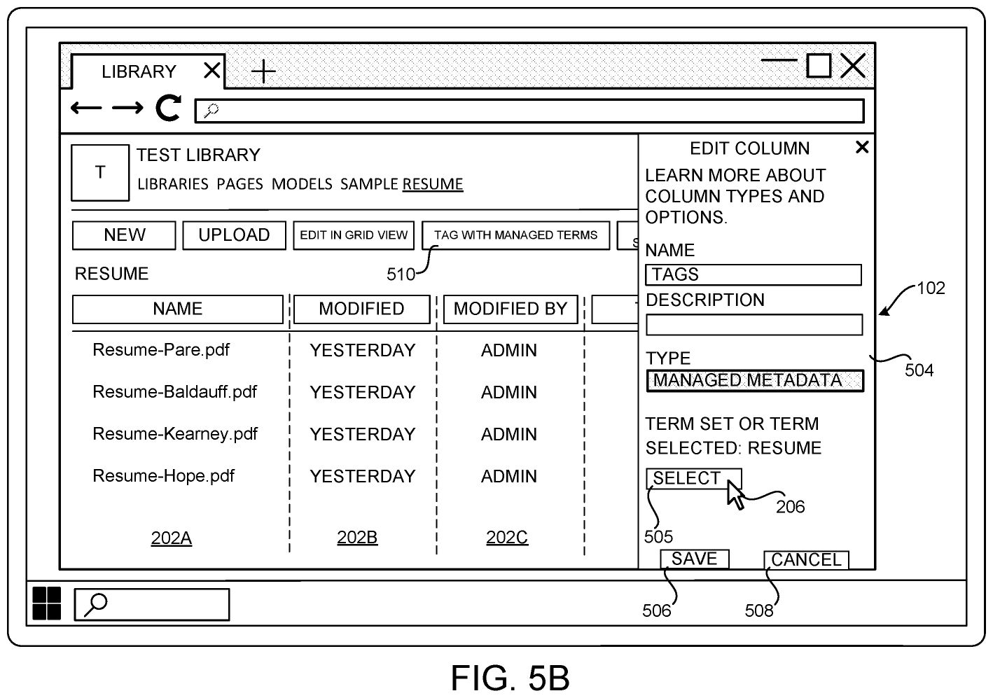

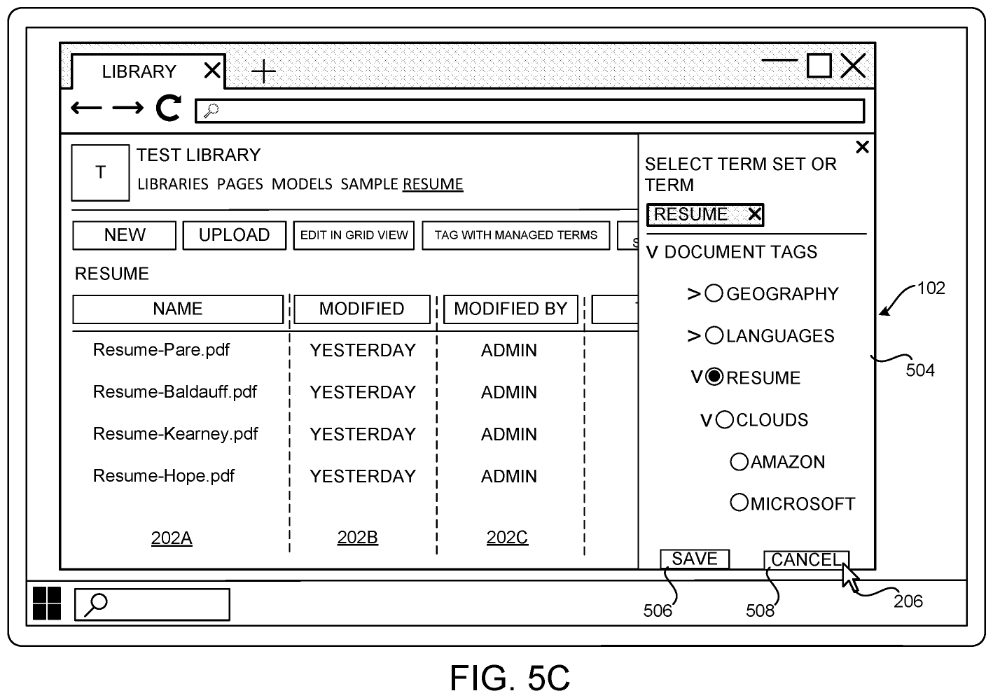

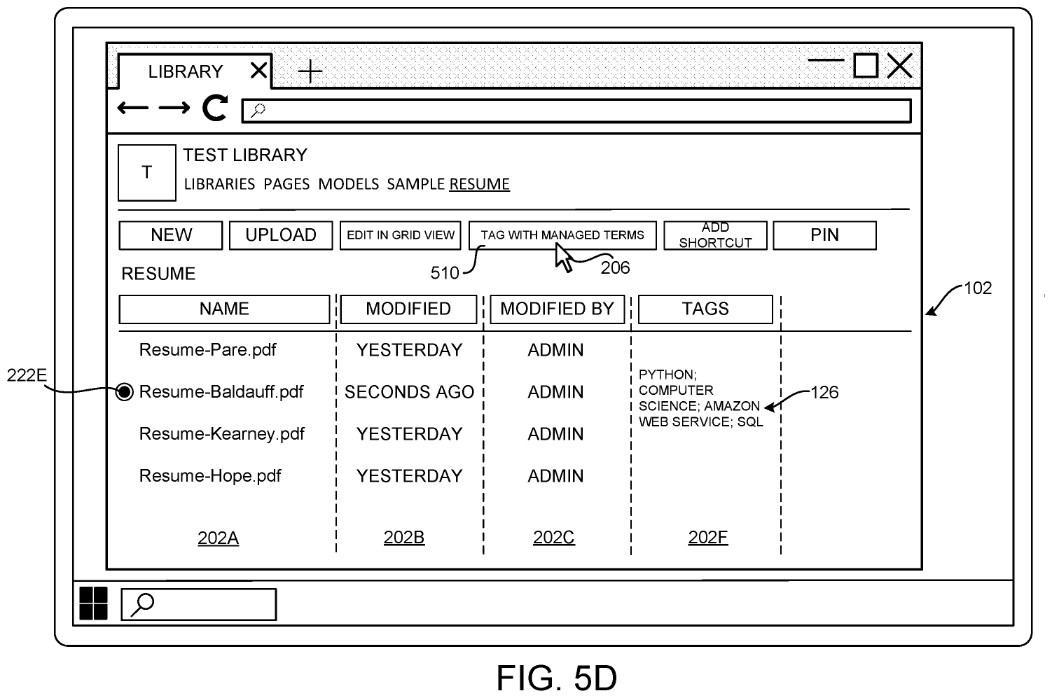

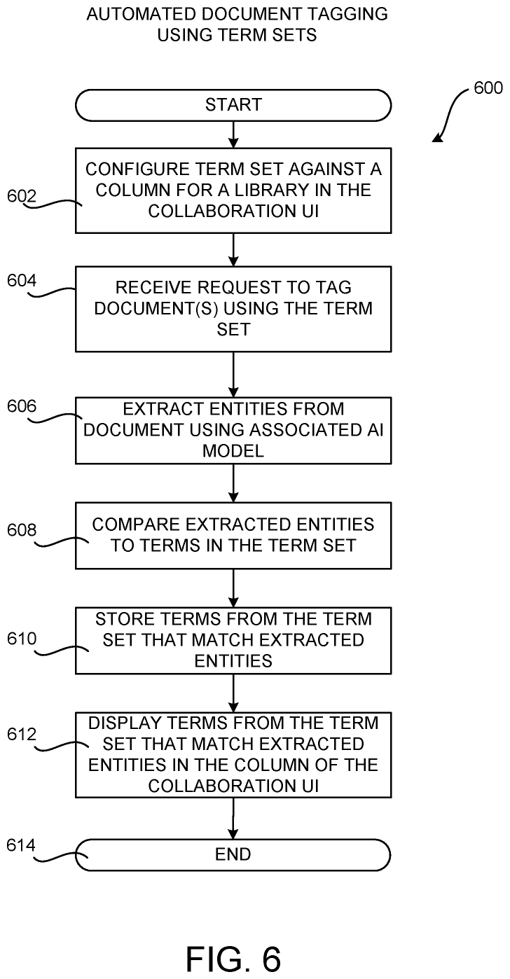

Modification of entities extracted from documents 112 in a document library 108 using a term set 124 might also be performed in response to new documents 112 being added to a document library 108 in some embodiments. Additional details regarding the mechanism illustrated in FIG. 1B and described briefly above for tagging documents 112 maintained by the collaboration platform 100 utilizing a term set 124 will be provided below with respect to FIGS. 5A-6.

FIGS. 2A-2D are UI diagrams illustrating aspects of the collaboration UI 102 provided by the collaboration platform shown in FIGS. 1A and 1B, according to one embodiment disclosed herein. In particular, FIGS. 2A-2D illustrate functionality provided by the collaboration UI 102 in one embodiment for enabling a user to initiate automated selection of an AI model 108 for performing entity extraction on documents 112 maintained by the collaboration platform 102. In this regard, it is to be appreciated that the configuration of the UIs shown in the FIGS. is merely illustrative and that other UI configurations can be utilized to access and utilize the functionality disclosed herein.

As discussed briefly above, the collaboration UI 102 provides functionality for enabling users to create, share, and collaborate on documents 112. As also described briefly above, the collaboration UI 102 also allows users of the collaboration platform 100 to organize documents 112 into document libraries 108. As shown in FIG. 2A, a user of the collaboration platform 100 can utilize the collaboration UI 102 to view the contents of a document library 108 and to perform various operations on the documents 112 contained therein.

In the example shown in FIG. 2A, for instance, a user has utilized the collaboration UI 102 to navigate to a document library 108 containing invoices. In response thereto, a listing of the documents 112 in the selected library 108 is shown. Additionally, a number of columns 202A-202C are displayed in the collaboration UI 102 that present various types of metadata associated with the documents 112 in the selected library 108. In the illustrated example, for instance, the column 202A displays the name of the documents 112 in the selected library 108, the column 202B displays the time at which documents 112 in the selected library were last modified, and the column 202C identifies the user that last modified the documents 112. Additional columns 202 can be configured to display different or additional information in other embodiments.

As also described briefly above, the collaboration UI 102 provides functionality through which a user of the computing device 104 can request a recommendation of an AI model 114 for performing entity extraction on documents 112 in a document library 108 maintained by the collaboration platform 100. In the embodiment illustrated in FIG. 2A, for instance, a user can select the UI control 204 utilizing an appropriate user input device mechanism, such by moving the mouse cursor 206 over the UI control 204 and selecting the UI control 204. Other types of user input can be utilized to initiate the functionality disclosed herein for requesting a recommendation of an AI model 114 for performing entity extraction on documents 112 in a document library 108 in other embodiments.

In response to receiving a request for a recommendation of an AI model 114 (i.e., the selection of the UI control 204 in one embodiment), the AI model discovery service 118 operating in the collaboration platform 100 can select several candidate documents 112 from the documents 112 in the current document library 108 and process the selected candidate documents 112 using AI models 114 configured to perform entity extraction.

Once the AI models 114 have performed their processing and extracted entities from the candidate documents 112, the AI model discovery service 118 operating in the collaboration platform 100 can then select one of the AI models (i.e., the selected AI model 120) based on the results of the entity extraction. Once the AI model discovery service 118 has selected an AI model 120, the selected AI model 120 might be identified to a user of the computing device 104. For example, in one embodiment, the collaboration UI 102 identifies the selected AI model 120 to the user. In the example shown in FIG. 2B, which continues the example from FIG. 2A, the collaboration UI 102 has presented a UI panel 208 indicating that an AI model 120 for extracting entities from invoice documents has been selected.

As also shown in FIG. 2B, the collaboration UI 102 can also identify the detected entities 122. In the illustrated example, for instance, the detected entities 122 include a billing address, customer name, invoice due date, invoice date, and remittance address.

The collaboration UI 102 also provides functionality for enabling a user to select one or more of the detected entities 122 that are to be extracted from documents 112 in the document library 108. In the example shown in FIG. 2B, for instance, a user has selected the UI controls 210A and 210B to indicate that the invoice due date and invoice date are to be extracted from the documents 112 in the selected document library 108.

In some embodiments, the collaboration UI 102 includes a UI control 212 which, when selected, will cause the collaboration platform 100 to create a new content type for documents 112 in a document library 108 following the selection of a recommended AI model 120. The new content type defines a document type for the documents 112 in the document library 108. The new content type also defines a schema identifying the selected entities that the recommended AI model 120 can extract from the documents 112 in the document library 108.

Once a user has made the appropriate selections in the collaboration UI 102, the user can then apply the selections to the document library 108. For example, and without limitation, when a user selects the UI control 214 using an appropriate user input mechanism such as the mouse cursor 206, the collaboration platform 100 will activate the selected AI model 120 for use in the current library 108. If the user does not want to apply the selections made in the collaboration UI 102, the user can select the UI control 216 to cancel the operation.

As shown in FIG. 2C, which continues the example from FIGS. 2A and 2B, the collaboration UI 102 can present a confirmation 218 to the user indicating that the selected AI model 120 has been activated for use in the current library 108. The collaboration UI 102 can also be updated to present new columns 202 that correspond to the detected entities 122 selected in the manner described above with reference to FIG. 2B. In the illustrated example, for instance, a new column 202D has been added corresponding to an invoice date and a new column 202E has been added that corresponds to an invoice due date.

Once the selected AI model 120 has been activated for use in the current library 108, a user can request that the selected AI model 120 be executed in order extract the selected entities (i.e., the entities selected using the UI controls 210) from selected documents 112 in the current document library 108. In the example shown in FIG. 2D, which continues the example from FIGS. 2A-2C, a user of the collaboration platform 100 has utilized the UI controls 222A-222D to select four documents 112 in the current document library 108. The user has also selected the UI control 220 with the mouse cursor 206 in order to request that the selected AI model 120 be utilized to extract the selected entities from the documents 112 selected using the UI controls 222.

In response to receiving the request from the user, the collaboration platform 100 causes the selected AI model 120 to process the selected documents 112 and identify the selected entities therein. Once the selected AI model 120 has performed its processing on the selected documents 112, the extracted entities can be written to metadata associated with the selected documents 112. The extracted entities can also be presented in the collaboration UI 102. For instance, in the illustrated example, the column 202D has been updated to show the extracted invoice date for each of the documents 112 selected with the UI controls 222. Similarly, the column 202E has been updated to show the extracted invoice due date for each of the documents 112 selected with the UI controls 222.

As discussed briefly above, in some embodiments the collaboration platform 100 causes the recommended AI model 114 to extract entities from new documents 112 added to the document library 108 in response to the new documents 112 being added to the document library 108. In this manner, the aspects of the collaboration UI 102 described above with reference to FIGS. 2A-2D are not required to be utilized in order to initiate extraction of entities from new documents 112 added to the document library 108. In this regard, it is to be appreciated that other events might trigger a request to the collaboration platform 100 to initiate extraction of entities from documents 112 in a document library 108 in other embodiments.

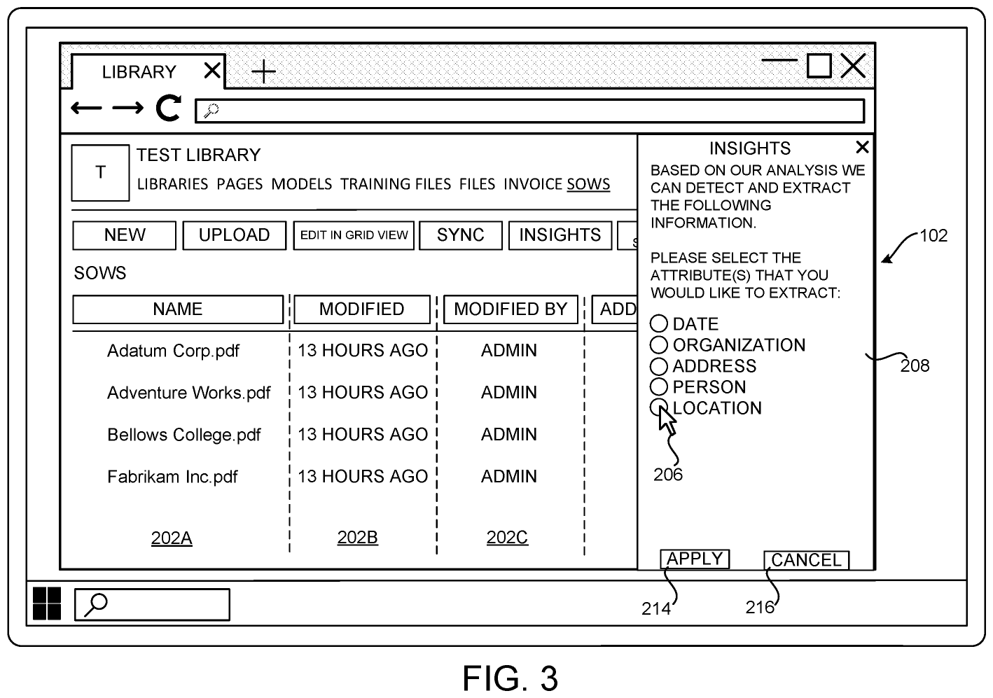

FIG. 3 is a UI diagram illustrating additional aspects of the collaboration user interface 102 provided by the collaboration platform 100 shown in FIGS. 1A and 1B, according to one embodiment disclosed herein. In the example shown in FIG. 3, a user of the collaboration platform 100 has utilized the collaboration UI 102 to navigate to a document library 108 that stores statements of work (“SOWs”). The user has also made a request for a recommendation of an AI model 114 in the manner described above with regard to FIG. 2A (i.e., through the selection of the UI control 204).

In response to receiving the request for a recommendation of an AI model 114, the AI model discovery service 118 operating in the collaboration platform 100 has selected several candidate documents 112 from the SOWs in the current document library 108 and processed the selected candidate documents 112 using AI models 114 configured to perform entity extraction. In this example, however, none of the AI models 114 was able to properly classify the documents 112 in the current document library 108. As a result, an AI model 114 configured to perform general entity extraction on abstract document types, as opposed to AI models 114 configured to perform entity extraction on specific document types, has been selected and has identified the entities that it can extract from the documents 112 in the document library 108. The entities that the selected AI model 114 can extract are shown in the UI pane 208 in the manner described above.

As in the example discussed above with regard to FIG. 2B, the user can select the entities to be extracted using an appropriate user input mechanism, such as the mouse cursor 206. Thereafter, the user can select the UI control 214 to apply the selection or the UI control 216 to cancel the operation. If the user selects the UI control 216, columns 202 for the selected entities are added to the collaboration UI 102. The user can then select documents 112 and request that the selected UI control 114 perform entity extraction on the selected documents 112 in the manner described above with regard to FIG. 2D.

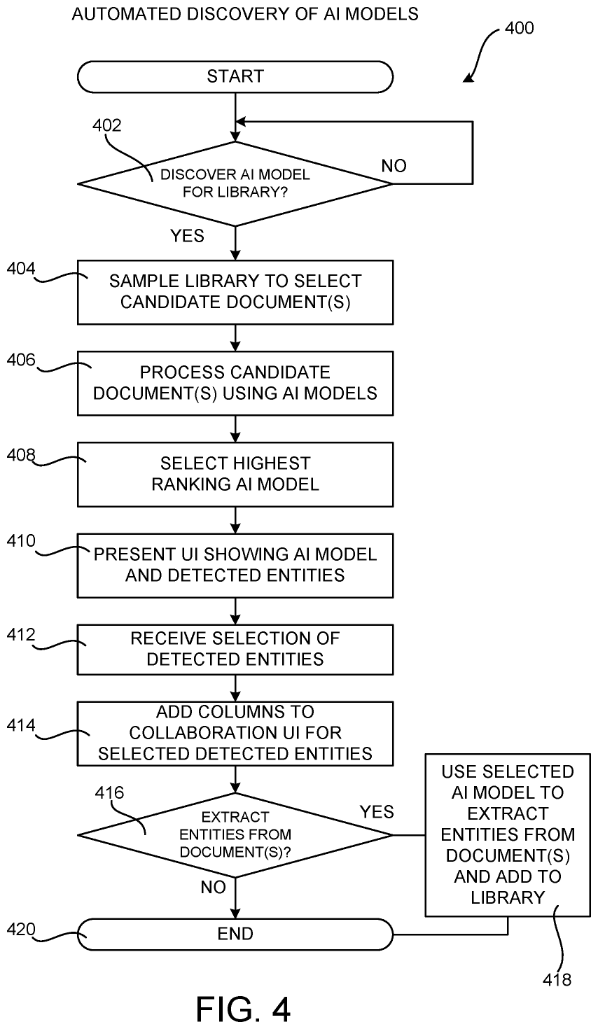

FIG. 4 is a flow diagram showing aspects of an illustrative routine 400 for automated discovery of AI models 114 for performing entity extraction on documents 112 maintained by the collaboration platform 100 shown in FIGS. 1A and 1B, according to one embodiment disclosed herein. In this regard, it is to be understood that the operations of the routines and methods disclosed herein are not presented in any particular order and that performance of some or all of the operations in an alternative order, or orders, is possible and is contemplated. The operations have been presented in the demonstrated order for ease of description and illustration. Operations may be added, omitted, and/or performed simultaneously, without departing from the scope of the appended claims. The illustrated routines and methods can end at any time and need not be performed in their entireties.

Some or all operations of the methods, and/or substantially equivalent operations, can be performed by execution of computer-readable instructions included on a computer-readable storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routines 400 and 600 are described herein as being implemented, at least in part, by modules implementing the features disclosed herein and can be a dynamically linked library (“DLL”), a statically linked library, functionality produced by an application programing interface (“API”), an network service, a compiled program, an interpreted program, a script or any other executable set of instructions. Data can be stored in a data structure in one or more memory components. Data can be retrieved from the data structure by addressing links or references to the data structure.

Although the following illustration refers to the components of the FIGS., it can be appreciated that the operations of the routines 400 and 600 may be also implemented in many other ways. For example, the routines 400 and 600 may be implemented, at least in part, by a processor of another remote computer or a local circuit. In addition, one or more of the operations of the routines 400 and 600 may alternatively or additionally be implemented, at least in part, by a chipset working alone or in conjunction with other software modules. In the example described below, one or more modules of a computing system can receive and/or process the data disclosed herein. Any service, circuit, or application suitable for providing the disclosed techniques can be used in operations described herein. The operations illustrated in FIGS. 4 and 6 can be performed, for example, by the computing device 700 of FIG. 7.

The routine 400 begins at operation 402, where the collaboration platform 100 receives a request for a recommendation of an AI model 114 for performing entity extraction on documents 112 in a document library 108. As discussed above, such a request might be received by way of the collaboration UI 102. Other types of events might also trigger such a request in other embodiments.

If such a request is received, the routine 400 proceeds from operation 402 to operation 404, where the AI model discovery service 118, or another component or components within the collaboration platform 100, samples the current document library 108 to select candidate documents 112 for use in selecting an AI model 114. The routine 400 then proceeds from operation 404 to operation 406, where the candidate documents 112 are processed by AI models 114 to identify the entities that can be extracted from the candidate documents 112.

Once the AI models 114 have finished extracting entities from the candidate documents 112, a score is generated for each of the AI models 114 and the highest ranking AI model 114 is selected. As discussed above, various mechanisms may be utilized to score the performance of the AI models 114 such as, but not limited to, a score based, at least in part, on the number of entities that each of the AI models 114 was able to identify in the candidate documents 112. Other methodologies might be utilized in other embodiments to score the performance of the AI models 114.

From operation 408, the routine 400 proceeds to operation 410 where the collaboration UI 102 shows the selected AI model 120 and the entities detected within the candidate documents 112. Aspects of an illustrative UI for performing this functionality were described above with reference to FIG. 2B.

From operation 410, the routine 400 proceeds to operation 412, where the collaboration platform 100 receives a selection of one or more of the detected entities in the manner described above with regard to FIG. 2B. Following the selection of one or more of the detected entities, the routine 400 proceeds from operation 412 to operation 414, where columns 202 are added to the collaboration UI 102 for the selected detected entities in the manner described above with regard to FIG. 2D.

From operation 414, the routine 400 proceeds to operation 416, where the collaboration platform 100 determines whether a request has been received to extract entities from one or more selected documents 112 in the current document library 108. If such a request is received, the routine 400 proceeds from operation 416 to operation 418, where the AI model 120 selected at operation 408 is utilized to extract entities from selected documents 112 in the current document library 108. The extracted entities are then added to the current document library 108 and displayed in a respective column 202 in the manner described above with regard to FIG. 2D. From operation 418, the routine 400 proceeds to operation 420, where it ends.

FIGS. 5A-5D are UI diagrams illustrating additional aspects of the collaboration UI 102 provided by the collaboration platform 100 shown in FIGS. 1A and 1B, according to one embodiment disclosed herein. In particular, FIGS. 5A-5D illustrate aspects of functionality provided by the collaboration platform 100 for performing automated document tagging using term sets 124 on documents 112 maintained by the collaboration platform 100.

In order to access this functionality, user input can be received by way of the collaboration UI 102 associating a term set 124 with a document library 108. For instance, a user might select a UI element for editing the settings associated with a column 202F of a document library 108. In the example shown in FIG. 5A, for instance, a user has utilized the mouse cursor 206 to select an appropriate UI element in the menu 502.

In response to the selection of the UI element illustrated in FIG. 5A, the UI pane 504 shown in FIG. 5B is displayed in some embodiments. The UI pane 504 provides information about the respective column 202D and provides a UI control 505 which, when selected, will provide a listing of term sets 124 that can be associated with the selected column 202F. An illustrative UI for performing this functionality is shown in FIG. 5C.

As discussed briefly above, a term set 124 defines terms that are to be utilized to replace detected entities 122 that are extracted from documents 112 in a document library 108. For example, and without limitation, the term set 124 might include preferred terms or synonyms for detected entities 122.

Once a term set 124 has been selected using, for example, the UI shown in FIG. 5C, the user can select the UI control 506 to save the selection or select the UI control 508 to cancel the selection. If the user opts to save the selection, the selected term set 124 is associated with the respective column 202F in the current document library 108. Thereafter, the user might select documents 112 in the current document library and select the UI control 510 in order to initiate tagging of the selected documents using the term set 124 associated with the column 202F.

In the example shown in FIG. 5D, for instance, a user has selected a document in the current document library 108 using the UI control 222E. The user has also selected the UI control 510 to tag the selected document with terms defined by the term set 124 associated with the column 202F. In response thereto, the document tagging service 128, or another component or components in the collaboration platform 100, compares the detected entities 122 extracted from the documents 112 in the document library 108 to terms in the term set 124.

Detected entities 122 extracted from the documents 122 in the document library 108 that match terms in the term set 124 can then be modified based on the comparison. For example, and without limitation, an entity extracted from a document 112 in the document library 108A might be replaced with a synonym or a preferred term for the extracted entity defined by the term set 124. The modified entities 126 extracted from the documents can then be stored in association with the document library 108 and displayed in the collaboration UI 102 as illustrated in FIG. 5D.

As discussed briefly above, modification of entities extracted from documents 112 in a document library 108 using a term set 124 might also be performed in response to new documents 112 being added to a document library 108 in some embodiments. Other actions might also trigger the use of a term set 124 in the manner described above in other embodiments.

FIG. 6 is a flow diagram showing aspects of an illustrative routine 600 for performing automated document tagging using a term set 124 on documents 112 maintained by the collaboration platform 100 shown in FIGS. 1A and 1B, according to one embodiment disclosed herein. The routine 600 begins at operation 602, where a user can configure a term set 124 against a column 202 in a document library 108 in the manner described above with regard to FIGS. 5A-5C. Other mechanisms for associating a term set 124 with a column 202 in a document library 108 can be utilized in other embodiments.

From operation 602, the routine 600 proceeds to operation 604, where the collaboration platform 100 receives a request to tag documents 112 in a document library 108 using an associated term set 124. One mechanism for initiating such a request was described above with regard to FIG. 5D.

In response to receiving the request at operation 604, the routine 600 proceeds to operation 606, where an associated AI model 114 is utilized to extract entities from one or more selected documents 112 in the current document library 108 in the manner described above. The routine 600 then proceeds from operation 606 to operation 608, where the document tagging service 128, or another component or components in the collaboration platform 100, compares the detected entities 122 extracted from the documents 112 in the document library 108 to terms in the term set 124.

From operation 608, the routine 600 proceeds to operation 610, where detected entities 122 extracted from the documents 122 in the document library 108 that match terms in the term set 124 may be modified based on the comparison. For example, and without limitation, an entity extracted from a document 112 in the document library 108A might be replaced with a synonym for the extracted entity defined by the term set 124. The modified entities 126 extracted from the documents can then be stored in association with the document library 108.

The routine 600 then proceeds from operation 610 to operation 612, where the modified entities 126 can be displayed in the collaboration UI 102 as illustrated in FIG. 5D. The routine 600 proceeds from operation 612 to operation 614, where it ends.

FIG. 7 is a computer architecture diagram showing an illustrative computer hardware and software architecture for a computing device 112 that can implement the various technologies presented herein. In particular, the architecture illustrated in FIG. 7 can be utilized to implement the computing device 104 and computing devices in the collaboration platform 100 for providing aspects of the functionality disclosed herein.

The computer 700 illustrated in FIG. 7 includes one or more central processing units 702 (“CPU”), a system memory 704, including a random-access memory 706 (“RAM”) and a read-only memory (“ROM”) 708, and a system bus 710 that couples the memory 704 to the CPU 702. A basic input/output system (“BIOS” or “firmware”) containing the basic routines that help to transfer information between elements within the computer 700, such as during startup, can be stored in the ROM 708.

The computer 700 further includes a mass storage device 712 for storing an operating system 722, application programs, and other types of programs. In one embodiment, an application program executing on the computer 700 provides the functionality described above with regard to FIGS. 1-6. Other modules or program components can provide this functionality in other embodiments. The mass storage device 712 can also be configured to store other types of programs and data.

The mass storage device 712 is connected to the CPU 702 through a mass storage controller (not shown) connected to the bus 710. The mass storage device 712 and its associated computer readable media provide non-volatile storage for the computer 700. Although the description of computer readable media contained herein refers to a mass storage device, such as a hard disk, CD-ROM drive, DVD-ROM drive, or USB storage key, it should be appreciated by those skilled in the art that computer readable media can be any available computer-readable storage media or communication media that can be accessed by the computer 700.

Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer-readable media.

By way of example, and not limitation, computer-readable storage media can include volatile and non-volatile, removable and non-removable media implemented in any method or technology for storage of information such as computer readable instructions, data structures, program modules or other data. For example, computer-readable storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer 700. For purposes of the claims, the phrase “computer-readable storage medium,” and variations thereof, does not include waves or signals per se or communication media.

According to various configurations, the computer 700 can operate in a networked environment using logical connections to remote computers through a network such as the network 720. The computer 700 can connect to the network 720 through a network interface unit 716 connected to the bus 710. It should be appreciated that the network interface unit 716 can also be utilized to connect to other types of networks and remote computer systems.

The computer 700 can also include an input/output controller 718 for receiving and processing input from a number of other devices, including a keyboard, mouse, touch input, an electronic stylus (not shown in FIG. 7), or a physical sensor 725 such as a video camera. Similarly, the input/output controller 718 can provide output to a display screen or other type of output device (also not shown in FIG. 7).

It should be appreciated that the software components described herein, when loaded into the CPU 702 and executed, can transform the CPU 702 and the overall computer 700 from a general-purpose computing device into a special-purpose computing device customized to facilitate the functionality presented herein. The CPU 702 can be constructed from any number of transistors or other discrete circuit elements, which can individually or collectively assume any number of states.

More specifically, the CPU 702 can operate as a finite-state machine, in response to executable instructions contained within the software modules disclosed herein. These computer-executable instructions can transform the CPU 702 by specifying how the CPU 702 transitions between states, thereby transforming the transistors or other discrete hardware elements constituting the CPU 702.

Encoding the software modules presented herein can also transform the physical structure of the computer readable media presented herein. The specific transformation of physical structure depends on various factors, in different implementations of this description. Examples of such factors include, but are not limited to, the technology used to implement the computer readable media, whether the computer readable media is characterized as primary or secondary storage, and the like. For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 700 in order to store and execute the software components presented herein. It also should be appreciated that the architecture shown in FIG. 7 for the computer 700, or a similar architecture, can be utilized to implement other types of computing devices, including hand-held computers, video game devices, embedded computer systems, mobile devices such as smartphones, tablets, AR and VR devices, and other types of computing devices known to those skilled in the art. It is also contemplated that the computer 700 might not include all of the components shown in FIG. 7, can include other components that are not explicitly shown in FIG. 7, or can utilize an architecture completely different than that shown in FIG. 7.

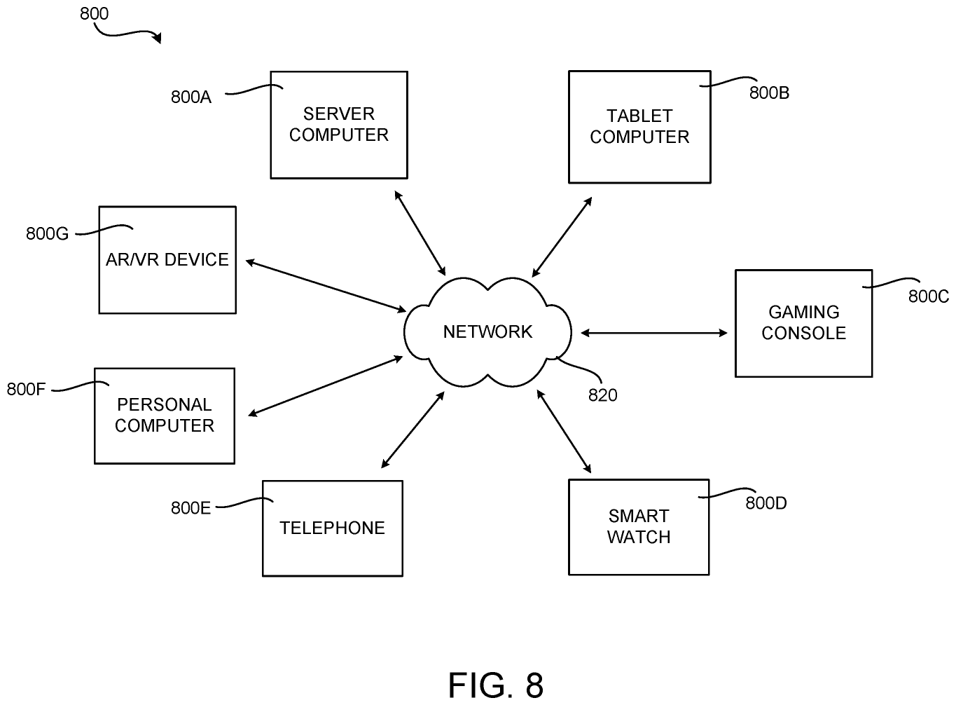

FIG. 8 is a network diagram illustrating a distributed network computing environment 800 in which aspects of the disclosed technologies can be implemented, according to various embodiments presented herein. As shown in FIG. 8, one or more server computers 800A can be interconnected via a communications network 820 (which may be either of, or a combination of, a fixed-wire or wireless LAN, WAN, intranet, extranet, peer-to-peer network, virtual private network, the Internet, Bluetooth communications network, proprietary low voltage communications network, or other communications network) with a number of client computing devices such as, but not limited to, a tablet computer 800B, a gaming console 800C, a smart watch 800D, a telephone 800E, such as a smartphone, a personal computer 800F, and an AR/VR device 800G.

In a network environment in which the communications network 820 is the Internet, for example, the server computer 800A can be a dedicated server computer operable to process and communicate data to and from the client computing devices 800B-800G via any of a number of known protocols, such as, hypertext transfer protocol (“HTTP”), file transfer protocol (“FTP”), or simple object access protocol (“SOAP”). Additionally, the network computing environment 800 can utilize various data security protocols such as secured socket layer (“SSL”) or pretty good privacy (“PGP”). Each of the client computing devices 800B-800G can be equipped with an operating system operable to support one or more computing applications or terminal sessions such as a web browser (not shown in FIG. 8), or other graphical UI, including those illustrated above, or a mobile desktop environment (not shown in FIG. 8) to gain access to the server computer 800A.

The server computer 800A can be communicatively coupled to other computing environments (not shown in FIG. 8) and receive data regarding a participating user's interactions/resource network. In an illustrative operation, a user (not shown in FIG. 8) may interact with a computing application running on a client computing device 800B-800G to obtain desired data and/or perform other computing applications.

The data and/or computing applications may be stored on the server 800A, or servers 800A, and communicated to cooperating users through the client computing devices 800B-800G over an exemplary communications network 820. A participating user (not shown in FIG. 8) may request access to specific data and applications housed in whole or in part on the server computer 800A. These data may be communicated between the client computing devices 800B-800G and the server computer 800A for processing and storage.

The server computer 800A can host computing applications, processes and applets for the generation, authentication, encryption, and communication of data and applications such as those described above with regard to FIGS. 1-6, and may cooperate with other server computing environments (not shown in FIG. 8), third party service providers (not shown in FIG. 8), network attached storage (“NAS”) and storage area networks (“SAN”) to realize application/data transactions.

In some embodiments, the server computer 800A provides implements the collaboration platform 100 described above. In these embodiments, the collaboration UI 102 may be presented on the client computing devices 800B-800G. For example, a personal computer 800F, such as a desktop or laptop computer, may provide the user interfaces shown in FIGS. 2A-3 and 5A-5D and described above. Other of the client computing devices 800 can provide similar functionality in a manner similar to that described above.

It should be appreciated that the computing architecture shown in FIG. 8 and the distributed network computing environment shown in FIG. 8 have been simplified for ease of discussion. It should also be appreciated that the computing architecture and the distributed computing network can include and utilize many more computing components, devices, software programs, networking devices, and other components not specifically described herein.

The disclosure presented herein also encompasses the subject matter set forth in the following clauses:

Clause 1. A computer-implemented method, comprising: processing one or more documents in a document library provided by a collaboration platform using a plurality of artificial intelligence (AI) models, the AI models configured to extract entities from the one or more documents; based on the processing, selecting an AI model from the plurality of AI models; identifying entities that the selected AI model can extract from the one or more documents; presenting a user interface identifying the entities that the selected AI model can extract from the one or more documents; receiving a selection by way of the user interface of one or more of the entities that the selected AI model can extract from the one or more documents; and causing the selected AI model to extract the selected one or more of the entities from documents in the document library.

Clause 2. The computer-implemented method of clause 1, further comprising: comparing the entities extracted from the documents in the document library to a term set; and modifying one or more of the entities extracted from the documents in the document library based on the comparison.

Clause 3. The computer-implemented method of any of clauses 1 or 2, further comprising: receiving user input associating the term set with the document library; and displaying the modified one or more entities extracted from the documents in the user interface.

Clause 4. The computer-implemented method of any of clauses 1-3, wherein the selected AI model extracts the selected one or more of the entities from documents in the document library responsive to a request received by way of the user interface.

Clause 5. The computer-implemented method of any of clauses 1-4, further comprising causing the selected AI model to extract the selected one or more of the entities from new documents added to the document library responsive to the new documents being added to the document library.

Clause 6. The computer-implemented method of any of clauses 1-5, wherein the plurality of AI models comprise one or more previously-trained AI models and one or more custom AI models.

Clause 7. The computer-implemented method of any of clauses 1-6, wherein the user interface further comprises a user interface control which, when selected, causes a new content type to be created, the new content type identifying a document type for the documents in the document library and a schema identifying the selected one or more of the entities.

Clause 8. A computer-readable storage medium having computer-executable instructions stored thereupon which, when executed by a computing device, cause the computing device to: process one or more documents in a document library provided by a collaboration platform using a plurality of artificial intelligence (AI) models, the AI models configured to extract entities from the one or more documents; select an AI model from the plurality of AI models based on the processing; identify entities that the selected AI model can extract from the one or more documents; and cause the selected AI model to extract one or more of the identified entities from documents in the document library.

Clause 9. The computer-readable storage medium of clause 8, having further computer-executable instructions stored thereupon which, when executed by the computing device, cause the computing device to: cause a user interface to be presented that identifies the entities that the selected AI model can extract from the one or more documents; receive a selection by way of the user interface of one or more of the entities that the selected AI model can extract from the one or more documents; receive a selection by way of the user interface of one or more documents in the document library; and cause the selected AI model to extract the selected one or more of the entities from the selected documents in the document library responsive to a request received by way of the user interface.

Clause 10. The computer-readable storage medium of any of clauses 8 or 9, having further computer-executable instructions stored thereupon which, when executed by the computing device, cause the computing device to: cause the selected AI model to extract entities from new documents added to the document library responsive to the new documents being added to the document library.

Clause 11. The computer-readable storage medium of any of clauses 8-10, wherein the user interface further comprises a user interface control which, when selected, will create a new content type, the new content type defining a document type for the documents in the document library and a schema identifying the selected one or more of the entities.

Clause 12. The computer-readable storage medium of any of clauses 8-11, wherein the plurality of AI models comprise one or more previously-trained AI models and one or more custom AI models.

Clause 13. The computer-readable storage medium of any of clauses 8-12, having further computer-executable instructions stored thereupon which, when executed by the computing device, cause the computing device to: compare the entities extracted from the documents in the document library to a term set; and modify one or more of the entities extracted from the documents in the document library based on the comparison.

Clause 14. The computer-readable storage medium of any of clauses 8-13, having further computer-executable instructions stored thereupon which, when executed by the computing device, cause the computing device to: receive user input associating the term set with the document library; and display the modified one or more entities extracted from the documents in the user interface.

Clause 15. A computing device, comprising: at least one processor; and a computer-readable storage medium having computer-executable instructions stored thereupon which, when executed by the at least one processor, cause the computing device to: process one or more documents in a document library provided by a collaboration platform using a plurality of artificial intelligence (AI) models, the AI models configured to extract entities from the one or more documents; select an AI model from the plurality of AI models based on the processing; identify entities that the selected AI model can extract from the one or more documents; and cause the selected AI model to extract one or more of the identified entities from documents in the document library.

Clause 16. The computing device of clause 15, wherein the computer-readable storage medium has further computer-executable instructions stored thereupon which, when executed by the computing device, cause the computing device to: cause a user interface to be presented that identifies the entities that the selected AI model can extract from the one or more documents; receive a selection by way of the user interface of one or more of the entities that the selected AI model can extract from the one or more documents; receive a selection by way of the user interface of one or more documents in the document library; and cause the selected AI model to extract the selected one or more of the entities from the selected documents in the document library responsive to a request received by way of the user interface.

Clause 17. The computing device of any of clauses 15 or 16, wherein the computer-readable storage medium has further computer-executable instructions stored thereupon which, when executed by the computing device, cause the computing device to: cause the selected AI model to extract the selected one or more of the entities from new documents added to the document library responsive to the new documents being added to the document library.

Clause 18. The computing device of any of clauses 15-17, wherein the user interface further comprises a user interface control which, when selected, will create a new content type, the new content type defining a document type for the documents in the document library and a schema identifying the selected one or more of the entities.

Clause 19. The computing device of any of clauses 15-18, wherein the plurality of AI models comprise one or more previously-trained AI models and one or more custom AI models.

Clause 20. The computing device of any of clauses 15-19, wherein the computer-readable storage medium has further computer-executable instructions stored thereupon which, when executed by the computing device, cause the computing device to: receive user input associating a term set with the document library; compare the entities extracted from the documents in the document library to the term set; modify one or more of the entities extracted from the documents in the document library based on the comparison; and display the modified one or more entities extracted from the documents in the user interface.

Based on the foregoing, it should be appreciated that technologies for automated selection of AI models for performing entity extraction on documents maintained by a collaboration platform have been disclosed herein. Although the subject matter presented herein has been described in language specific to computer structural features, methodological and transformative acts, specific computing machinery, and computer readable media, it is to be understood that the subject matter set forth in the appended claims is not necessarily limited to the specific features, acts, or media described herein. Rather, the specific features, acts and mediums are disclosed as example forms of implementing the claimed subject matter.

The subject matter described above is provided by way of illustration only and should not be construed as limiting. Various modifications and changes can be made to the subject matter described herein without following the example configurations and applications illustrated and described, and without departing from the scope of the present disclosure, which is set forth in the following claims.

What is claimed is:

1. A computer-implemented method, comprising:
processing one or more documents in a document library provided by a collaboration platform using a plurality of artificial intelligence (AI) models, the AI models configured to extract entities from the one or more documents;
based on the processing, selecting an AI model from the plurality of AI models;
identifying entities that the selected AI model can extract from the one or more documents;
presenting a user interface identifying the entities that the selected AI model can extract from the one or more documents;
receiving a selection by way of the user interface of one or more of the entities that the selected AI model can extract from the one or more documents; and
causing the selected AI model to extract the selected one or more of the entities from documents in the document library.

2. The computer-implemented method of claim 1, further comprising:
comparing the entities extracted from the documents in the document library to a term set; and
modifying one or more of the entities extracted from the documents in the document library based on the comparison.

3. The computer-implemented method of claim 2, further comprising:
receiving user input associating the term set with the document library; and
displaying the modified one or more entities extracted from the documents in the user interface.

4. The computer-implemented method of claim 1, wherein the selected AI model extracts the selected one or more of the entities from documents in the document library responsive to a request received by way of the user interface.

5. The computer-implemented method of claim 1, further comprising causing the selected AI model to extract the selected one or more of the entities from new documents added to the document library responsive to the new documents being added to the document library.

6. The computer-implemented method of claim 1, wherein the plurality of AI models comprise one or more previously-trained AI models and one or more custom AI models.

7. The computer-implemented method of claim 1, wherein the user interface further comprises a user interface control which, when selected, causes a new content type to be created, the new content type identifying a document type for the documents in the document library and a schema identifying the selected one or more of the entities.

8. A computer-readable storage medium having computer-executable instructions stored thereupon which, when executed by a computing device, cause the computing device to:
process one or more documents in a document library provided by a collaboration platform using a plurality of artificial intelligence (AI) models, the AI models configured to extract entities from the one or more documents;
select an AI model from the plurality of AI models based on the processing;
identify entities that the selected AI model can extract from the one or more documents; and
cause the selected AI model to extract one or more of the identified entities from documents in the document library.

9. The computer-readable storage medium of claim 8, having further computer-executable instructions stored thereupon which, when executed by the computing device, cause the computing device to:
cause a user interface to be presented that identifies the entities that the selected AI model can extract from the one or more documents;
receive a selection by way of the user interface of one or more of the entities that the selected AI model can extract from the one or more documents;
receive a selection by way of the user interface of one or more documents in the document library; and
cause the selected AI model to extract the selected one or more of the entities from the selected documents in the document library responsive to a request received by way of the user interface.

10. The computer-readable storage medium of claim 8, having further computer-executable instructions stored thereupon which, when executed by the computing device, cause the computing device to:
cause the selected AI model to extract entities from new documents added to the document library responsive to the new documents being added to the document library.

11. The computer-readable storage medium of claim 8, wherein the user interface further comprises a user interface control which, when selected, will create a new content type, the new content type defining a document type for the documents in the document library and a schema identifying the selected one or more of the entities.

12. The computer-readable storage medium of claim 8, wherein the plurality of AI models comprise one or more previously-trained AI models and one or more custom AI models.

13. The computer-readable storage medium of claim 8, having further computer-executable instructions stored thereupon which, when executed by the computing device, cause the computing device to:
compare the entities extracted from the documents in the document library to a term set; and
modify one or more of the entities extracted from the documents in the document library based on the comparison.

14. The computer-readable storage medium of claim 13, having further computer-executable instructions stored thereupon which, when executed by the computing device, cause the computing device to:
receive user input associating the term set with the document library; and
display the modified one or more entities extracted from the documents in the user interface.

15. A computing device, comprising:
at least one processor; and
a computer-readable storage medium having computer-executable instructions stored thereupon which, when executed by the at least one processor, cause the computing device to:
process one or more documents in a document library provided by a collaboration platform using a plurality of artificial intelligence (AI) models, the AI models configured to extract entities from the one or more documents;
select an AI model from the plurality of AI models based on the processing;
identify entities that the selected AI model can extract from the one or more documents; and
cause the selected AI model to extract one or more of the identified entities from documents in the document library.

16. The computing device of claim 15, wherein the computer-readable storage medium has further computer-executable instructions stored thereupon which, when executed by the computing device, cause the computing device to:
cause a user interface to be presented that identifies the entities that the selected AI model can extract from the one or more documents;
receive a selection by way of the user interface of one or more of the entities that the selected AI model can extract from the one or more documents;
receive a selection by way of the user interface of one or more documents in the document library; and
cause the selected AI model to extract the selected one or more of the entities from the selected documents in the document library responsive to a request received by way of the user interface.

17. The computing device of claim 16, wherein the computer-readable storage medium has further computer-executable instructions stored thereupon which, when executed by the computing device, cause the computing device to:
cause the selected AI model to extract the selected one or more of the entities from new documents added to the document library responsive to the new documents being added to the document library.

18. The computing device of claim 15, wherein the user interface further comprises a user interface control which, when selected, will create a new content type, the new content type defining a document type for the documents in the document library and a schema identifying the selected one or more of the entities.

19. The computing device of claim 15, wherein the plurality of AI models comprise one or more previously-trained AI models and one or more custom AI models.

20. The computing device of claim 15, wherein the computer-readable storage medium has further computer-executable instructions stored thereupon which, when executed by the computing device, cause the computing device to:
receive user input associating a term set with the document library;
compare the entities extracted from the documents in the document library to the term set;
modify one or more of the entities extracted from the documents in the document library based on the comparison; and
display the modified one or more entities extracted from the documents in the user interface.
